(19) United States
(12) Patent Application Publication
(10) Pub. No.: US 2005/0131854 A1
(43) Pub. Date: Jun. 16, 2005

(54) Dynamic command line user interface

(75) Inventors: Ted. F. Slupesky, Portland, OR (US); Robert P. Grant, Mt. Pleasant, SC (US); Todd W. Bates, Portland, OR (US); Martine B. Wedlake, Hillsboro, OR (US)

Correspondence Address: LIEBERMAN & BRANDSDORFER, LLC, 12221 MCDONALD CHAPEL DRIVE, GAITHERSBURG, MD, 20878, US

(73) Assignee: International Business Machines Corporation, Armonk, NY (US)

(21) Appl. No.: 10/733,559

(22) Filed: Dec. 11, 2003

(51) Int. Cl. G06F 7/00

(52) U.S. Cl. 707/1

(57) ABSTRACT

A method and system for communicating with a managed object. An operator utilizes a user interface tool to initiate communication with the managed object through a server in communication with the managed object. A syntax tree pertaining to the meta data file of the managed object is created in real-time. The syntax tree informs the operator of the required syntax for a command, and parses data entered by the operator for appropriate formatting and presentation. Accordingly, the user interface enables dynamic communication of syntax and response formatting between the operator and the managed object.

### BACKGROUND OF THE INVENTION

1. Technical Field

This invention relates to systems management. More specifically, the invention relates to a system and method for dynamic user interface for managing computer-implemented systems.

2. Description of the Prior Art

Management of computer systems has become increasingly complex. Device management tools are required to provide a common look and feel for all devices being managed. It is known in the art for managed objects to have meta data description of functions to which operators may need to control. Meta data is defined as data or information about other data. Implementing a common look and feel in command lines in the prior art has been accomplished by developing a basic command line template library and then implementing various commands using the template. This results in a large number of command line tools that perform similar functions. In addition, the template library requires a large amount of redundant software that translates syntax into specific routines and data needed to implement the functionality.

FIG. 1 is a flow chart (10) illustrating a prior art process of communicating with a managed object of a computer system. The operator invokes a command line interface with a command to communicate with the managed object (12). The command line interface then consults with built-in parse information (14). Following the consultation, the command line interface interprets the operator command from step (10) according to the parse information (16), and searches a pre-programmed syntax tree for a command name matching the command provided by the operator (18). A test is then conducted to determine if the operator input command was found in the syntax tree (20). A negative response to the test at step (20) is indicative of a syntax error. A message is provided to the operator indicating that the operator command syntax is improper (22). However, a positive response to the test at step (20) is indicative that the operator command syntax is proper, and the remainder of the operator input command is parsed for required and optional arguments according to the syntax tree (24). A subsequent test is then conducted to determine if the operator's command input is well formed (26). A negative response to the test at step (26) is an indication that there is a syntax error associated with the operator input command (28). A message is provided to the operator indicating that the command is invalid, and correct usage with an illustration of the correct parameters may be provided. However, a positive response to the test at step (26) is an indication that the parse has been completed. In response to a completed parse of the operator command, the managed object invokes an action on the server using hard wired mapping between the command and the action (30). The server performs the action and returns a response to the command line interface (32). Thereafter, the command line interface receives the response provided by the server, formats the response, and displays the response to the operator (34). Formatting of the response is conducted via an ad hoc method. Accordingly, the typical prior art approach enables communication with a managed object through the use of hard wired parse information.

There are several shortcomings associated with the prior art method for implementation of a command line interface to communicate with a managed object. For example, the prior art method utilizes pre-programmed parse information to communicate with a plurality of managed objects. As a result, the prior art approach requires a large quantity of redundant software to translate an operator command to a specific routine. In addition, a large quantity of redundant data associated with the software translation is required to implement the functionality associated with the operator command. Due to the redundant software and associated data of the prior art approach, there are limitations reflected in the user interface. Such limitations may include limiting a quantity of managed objects to which a command line interface may communicate, as well as limiting functionality associated with the user interface. There is therefore a need for an efficient method and system to enable a single user interface to communicate with a wide array of managed objects by dynamically creating commands based upon meta data of a specified managed object.

### SUMMARY OF THE INVENTION

The present invention comprises a user interface to dynamically enhance communication with a managed object.

In one aspect of the invention, a method is provided for communicating with a managed object. An interpretable format from a meta data description for a function of the object is dynamically generated. An operator input command is interpreted according to the format, and an appropriate action is invoked on the managed object in response to the interpretation.

In another aspect of the invention, a computer system with a managed object is provided. A manager is provided to dynamically generate an interpretable format from a meta data description for the managed object, and an interpreter is provided to translate an input command according to the interpretable format. An action is invoked on the managed object is response to the translation.

In yet another aspect of the invention, an article is provided with a computer-readable signal-bearing medium. Means in the medium are provided for dynamically generating an interpretable format from a meta data description associated with a function of a managed object. In addition, means in the medium are provided for interpreting an operator input command based upon the interpretable format. Thereafter, means in the medium are provided for invoking an action of the managed object responsive to the interpretation.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart of a prior art process for a user interface communicating with a managed object.

FIGS. 2a and 2b are flow charts for a user interface communicating with a managed object according to the preferred embodiment of this invention. FIG. 2a is suggested for printing on the first page of the issued patent.

FIG. 3 is a flow chart illustrating interpretation response data from the managed object to the user interface.

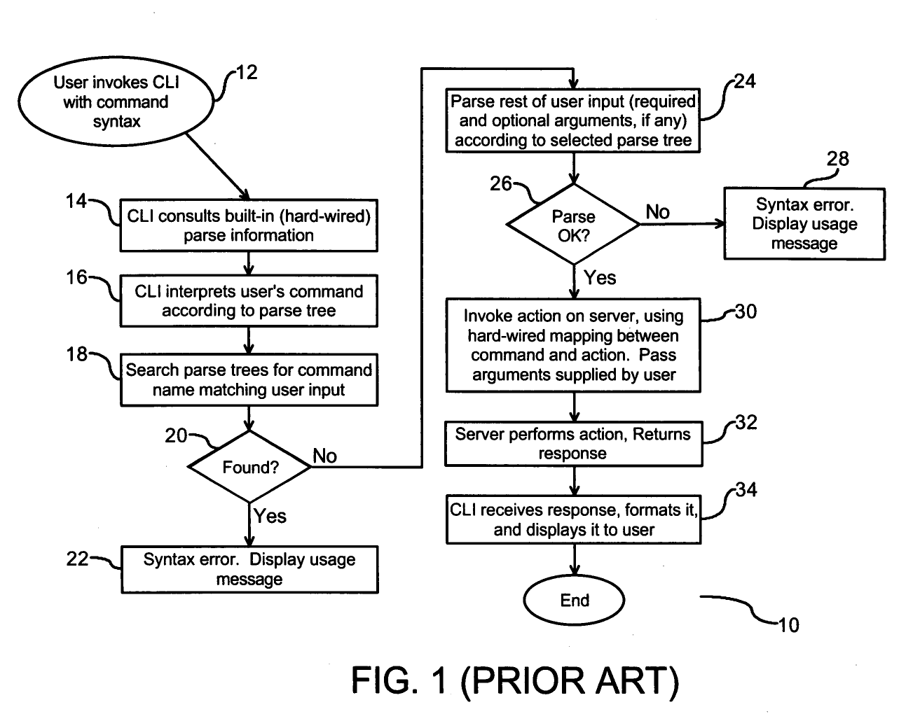

### DESCRIPTION OF THE PREFERRED EMBODIMENT

### Overview

A computer system typically includes a plurality of hardware devices that require management. Such hardware devices are known in the art as managed objects, and may include storage devices, such as disk arrays, a server having a product line with different versions, and a router. Each of these managed objects requires a user interface that enables an operator to efficiently communicate with the object. The user interface dynamically creates a syntax tree from a metadata file of the managed object and interprets an operator command according to the syntax tree. Accordingly, the syntax tree enables an operator to communicate with the managed object through a user interface that dynamically generates the appropriate commands.

### Technical Details

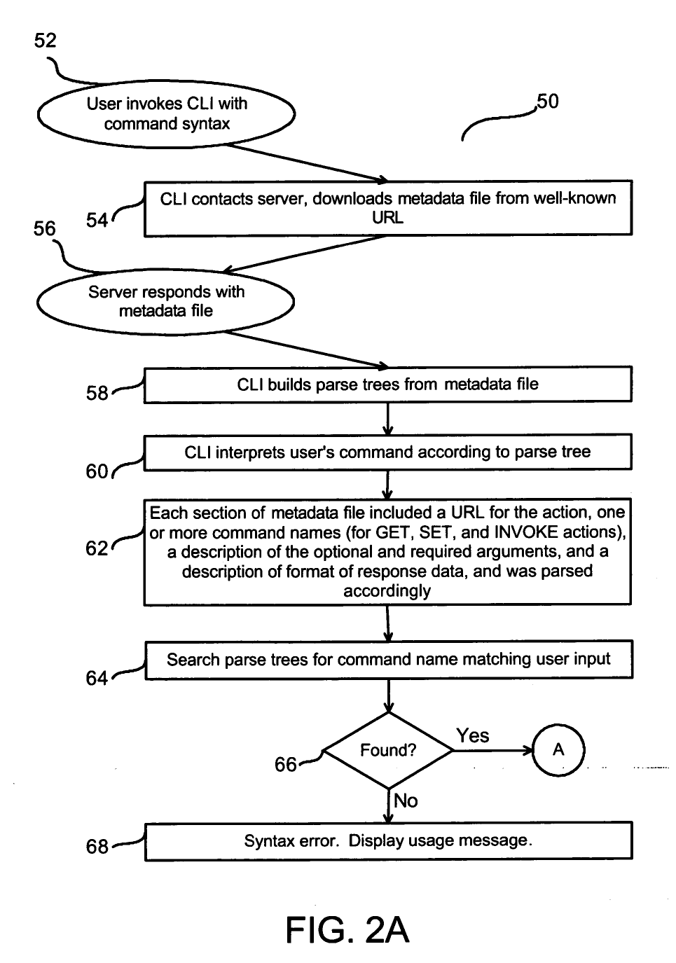

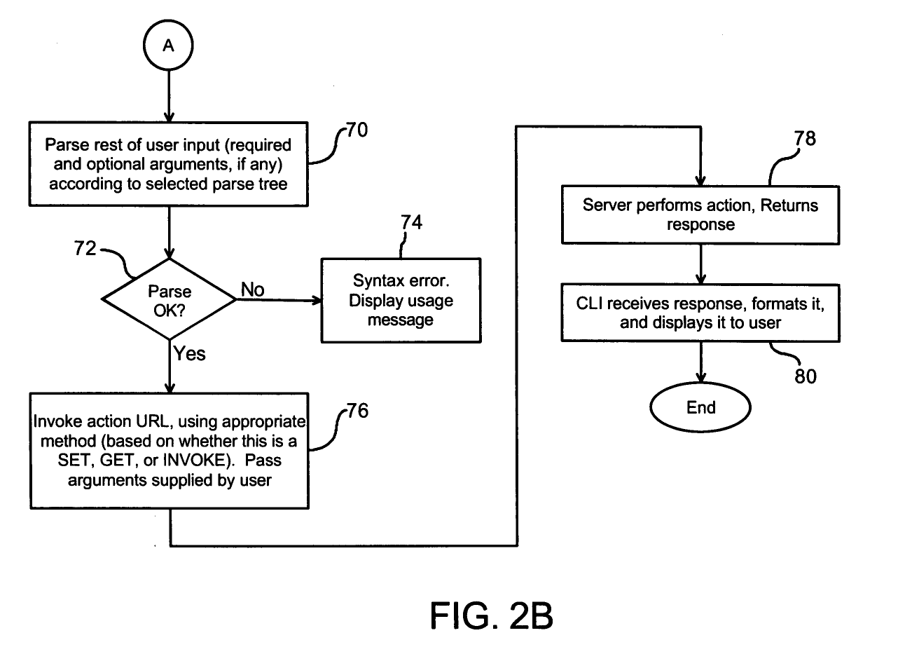

FIG. 2a is a flow chart (50) illustrating the process of communicating with a managed object. The operator invokes a user interface with a command to communicate with the managed object (52). The user interface may be applicable to a command line interface or a graphical user interface. Following step (52), the user interface contacts the managed object specified at step (52). A network connection with the managed object is established and metadata describing commands and data associated with the managed object is downloaded from a location pre-established between the user interface and the managed object (54). The server responds to the metadata request with the appropriate metadata file associated with the managed object specified (56). The user interface dynamically builds syntax trees from the metadata file in response to an initial communication with the managed object (58). The syntax trees are used to both inform the operator of the required syntax of the commands, in the case of a syntax error, as well as to reliably parse data entered by the operator, in the case of the syntax being well formed. The operator's commands are then interpreted according to the syntax tree (60). Accordingly, creation of the syntax tree in response to an initiation of communication with a specified managed object enables the user interface to determine available syntax for communication and management of the specified object.

Each section of the metadata file could include the following: a uniform resource locator (URL) assigned to an attribute or a function of the managed object, one or more command names, a description of both optional and required arguments, and a description of the format of response data. There are three types of internal commands that are supported by both the user interface and the managed object, which are used by the user interface for communication with the managed object. The GET command enables an operator to request data from the managed object. The SET command enables simple modifications of existing data. The INVOKE command enables complex operations associated with the managed object, including creation of new data. Together, these three internal commands in conjunction with URLs for attributes of the managed object(s) encompass all the various device management operations. Each of the three commands may be invoked for one URL assigned to an attribute of the managed object, instead of a separate URL for each command for one attribute of the managed object. For example, a URL may be assigned to the internet protocol (IP) address of a managed object. User operations may require viewing and changing the IP address. Those operations may be mapped onto the GET and SET internal commands applied to or operating on the URL that identifies an IP address attribute. Accordingly, the assignment of a URL to an attribute of the managed object, together with the user interface support commands, enables an operator to efficiently communicate with the managed object.

Following interpretation of the operator command at step (60), each section of the metadata file is parsed accordingly (62). The syntax tree created at step (58) is then searched for a command name matching the command provided by the operator (64). A test is then conducted to determine if the operator input command was found in the syntax tree (66). A negative response to the test at step (66) is indicative of a syntax error. A message is provided to the operator indicating that the operator command syntax is improper (68). However, a positive response to the test at step (66) is indicative that the operator command syntax is proper, and the remainder of the operator input command(s) is parsed for required and optional arguments (70). FIG. 2b is a continuation of the flow chart of FIG. 2a, further illustrating the communication with a managed object. Following step (70) in which the remainder of the operator input command(s) is parsed, a subsequent test is conducted to determine if the operator's command input conforms to the syntax specified by the syntax tree (72). A negative response to the test at step (72) is an indication that there is a syntax error associated with the operator input command (74). A message is provided to the operator indicating that the command is invalid, and correct usage with an illustration of the correct parameters may be provided. However, a positive response to the test at step (72) is an indication that the parse has been completed. In response to a completed parse of the operator command, the managed object performs that input command and returns a response to the operator (76). The action at step (76) includes invoking an action on the appropriate URL of the specified attribute of the managed object using at least one of the GET, SET, or INVOKE commands. A server performs the assigned action and returns a response to the user interface (78). Thereafter, the response is formatted and displayed to the operator (80). Accordingly, following the process of building a syntax tree to interpret an operator input command, the syntax tree is used to interpret the operator command syntax.

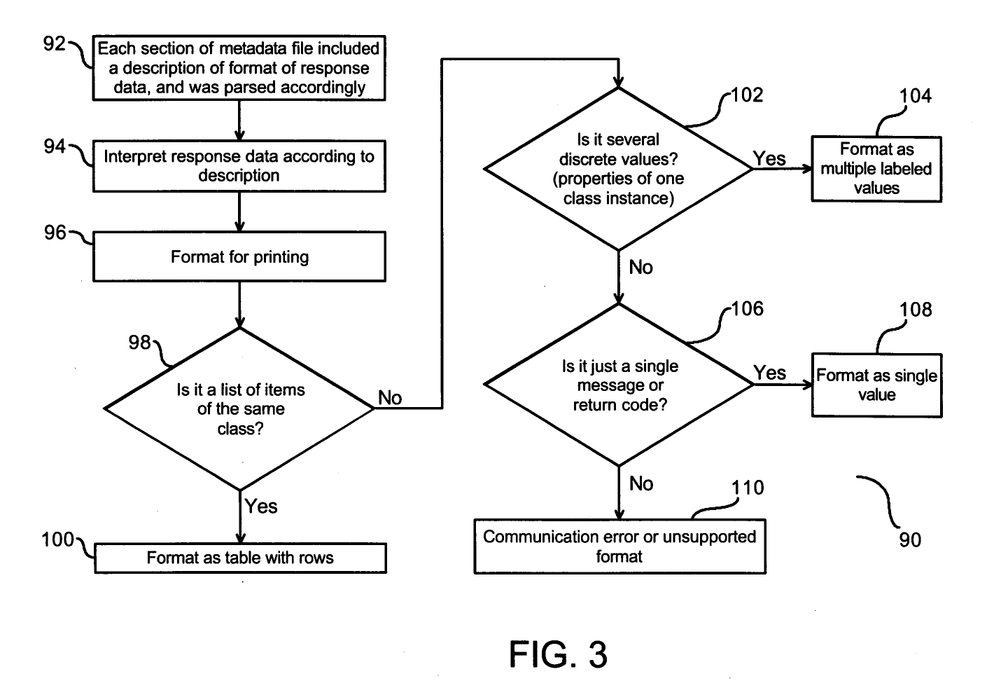

As mentioned above, following the processing of the operator input in step (78) of FIG. 2b, the user interface formats the data received from the server for presentation to the operator. FIG. 3 is a flow chart (90), illustrating the process of interpreting and formatting meta data response information and communicating it to the operator. Each section of the metadata file included a description of the format of the response, and was parsed accordingly (92). The user interface interprets the response data according to the meta data file description (94). For example, the user interface may be interpreting a listing of data and converting the listing to a table format. The interpreted data is then formatted for printing (96). Thereafter, a test is conducted to determine if the formatted items are all of the same classification (98), e.g. multiple items belonging to a single category of information. A positive response to the test at step (98), will result in a proper formatting of the data for presentation to the operator (100), e.g. as a table. However, a negative response to the test at step (98), will result in a subsequent test to determine if there are a plurality of discrete values associated with the interpreted data (102). A positive response to the test at step (102) will result in formatting the interpreted data as multiple labeled values (104). However, a negative response to the test at step (102) will result in a subsequent test to determine if there is a single message or return code (106). A positive response to the test at step (106) will result in formatting the interpreted data as a single value (108), and a negative response to the test at step (106) will results in a communication error with the managed object (110). Accordingly, following the process of dynamically interpreting an operator command for a managed object, the user interface proceeds to translate response data from the managed object to the operator in an interpretable format.

### Advantages Over the Prior Art

The user interface allows for communication with a wide array of managed objects. Commands appropriate for communication with the managed object are dynamically generated in response to the initial communication with the server managing the managed object. The process of dynamically building a syntax tree in response to an operator invoked command with a managed object allows the user interface to communicate with any managed object. This method and system eliminates the requirement of preprogramming parse information into the user interface, and provides a common look and feel for all devices being managed. Accordingly, the user interface of the preferred embodiment enables communication with any managed object in real-time from a single tool.

### Alternative Embodiments

It will be appreciated that, although specific embodiments of the invention have been described herein for purposes of illustration, various modifications may be made without departing from the spirit and scope of the invention. In particular, the managed object may include a plurality of hardware components that have a communication port to enable receipt and transmission of data to and from the managed object. Accordingly, the scope of protection of this invention is limited only by the following claims and their equivalents.

1. A method of communicating with a managed object, comprising:
(a) dynamically generating an interpretable format from a meta data description for a function of said object;
(b) interpreting an operator input command according to said format; and
(c) invoking an appropriate action on said managed object in response to said interpretation.

2. The method of claim 1, further comprising translating a response received from said managed object into said interpretable format.

3. The method of claim 1, wherein said meta data description for a function of said object includes a uniform resource locator assigned to said function.

4. The method of claim 3, wherein said meta data describes one or more internal commands associated with said function.

5. The method of claim 1, wherein the step of dynamically generating an interpretable format from a meta data description includes building a data structure to inform an operator of a required format for communication with said managed object.

6. The method of claim 1, further comprising said interpretable format dynamically interpreting response data.

7. The method of claim 1, wherein the step of dynamically generating an interpretable format from a meta data description for a function of said object includes an interface selected from a group consisting of: a command line interface, and a graphical user interface.

8. A computer system with a managed object comprising:
a manager adapted to dynamically generate an interpretable format from a meta data description for said managed object; and
an interpreter adapted to translate an input command according to said interpretable format, wherein an action is invoked on said managed object in response to said translation.

9. The system of claim 8, wherein a meta data description for a function of said object includes a uniform resource locator assigned to said function.

10. The system of claim 9, wherein said meta data description includes one or more internal commands associated with said function.

11. The system of claim 8, wherein said manager builds a data structure to inform an operator of a required format for communication with said managed object.

12. The system of claim 8, further comprising a response manager to dynamically interpret response data.

13. The system of claim 8, wherein said manager is selected from a group consisting of: a command line interface, and a graphical user interface.

14. An article comprising:
a computer-readable signal-bearing medium;
means in the medium for dynamically generating an interpretable format from a meta data description associated with a function of a managed object;
means in the medium for interpreting an operator input command based upon said interpretable format; and
means in the medium for invoking an action of said managed object responsive to said interpretation.

15. The article of claim 14, wherein the medium is selected from the group of: a recordable data storage medium and a modulated carrier signal.

16. The article of claim 14, wherein said meta data description includes a uniform resource locator assigned to said function.

17. The article of claim 14, wherein said meta data describes one or more internal commands associated with said function.

18. The article of claim 14, wherein said means for dynamically generating an interpretable format from a meta dat description includes a data structure of a required format for communication with said managed object.

19. The article of claim 14, wherein said means for interpreting an operator input command dynamically translates response data.

20. The article of claim 14, wherein said means in the medium for dynamically generating an interpretable format from a meta data description associated with a function of a managed object is selected from a group consisting of: a command line interface, and a graphical user interface.
